(19) United States
(12) Patent Application Publication
(10) Pub. No.: US 2015/0289495 A1
(43) Pub. Date: Oct. 15, 2015

(54) Bedbug Tape

(71) Applicant: Walter Olszak, Flint, MI (US)

(72) Inventor: Walter Olszak, Flint, MI (US)

(21) Appl. No.: 14/251,781

(22) Filed: Apr. 14, 2014

(51) Int. Cl. A01M 1/02; A01M 1/00

(52) U.S. Cl. CPC A01M 1/02; A01M 1/00

(57) ABSTRACT

Bedbug Tape is a product and method to control and deter bedbugs, using two-sided tape that is coated with diatomaceous earth. The Diatomaceous Earth is applied as the tape is being pulled from its package, or Diatomaceous Earth is applied to tape and packaged ready for use, enabling it to be put in the paths of bedbugs traveling to and from hiding spots hiding and laying eggs. The tape can be placed by cracks on floor to wall areas, around bedpost legs, across the bottom and sides of beds and furniture. The Diatomaceous Earth damages the insects' exoskeletons, and causes them to dry out and die. Preferably the Diatomaceous Earth is non-toxic and food-grade, and does not otherwise harm humans or pets.

### BACKGROUND OF THE INVENTION

1. Field of the Invention

The present invention pertains to a tape for deterring bedbugs. More particularly, the present invention pertains to a double-sided tape having diatomaceous earth applied to one side of the tape to be used to create a barrier to deter and kill bedbugs.

2. Description of the Prior Art

Bedbugs are a parasite that feed exclusively on blood, and they are known primarily to be a human parasite. The first written description of bedbugs dates back to Greece around 400 B.C. Over the years, numerous methods for attempting to deter and kill bedbugs have been used. For example, the use of plants, fungi, or other insects have been used. The methods that have been tried vary greatly, and even smoke from peat fires was recommended as an indoor fumigant for bedbugs during the 19^{th} Century.

More recently, diatomaceous earth, or Kieselguhr, has been increasingly used as a nontoxic residual pesticide for bedbug abatement. Diatomaceous earth consists of fossilized remains of diatoms, a type of hard-shelled algae. It is used as a filtration aid, mild abrasive in products including toothpaste, and a mechanical insecticide. Insects exposed to diatomaceous earth may take several days to die. The diatomaceous earth absorbs lipids from the waxy outer layer of insects' exoskeletons, causing them to dehydrate and die. It is effective against bedbugs, dust mite, cockroaches, ants, and fleas.

Diatomaceous earth is a naturally occurring, soft, siliceous sedimentary rock that is easily crumbled into a fine white to off-white powder. It has a particle size ranging from less than 3 micrometers to more than 1 millimeter, but typically 10 to 200 micrometers. Depending on the granularity, diatomaceous earth powder can have an abrasive feel, similar to pumice powder, and it is very light as a result of its high porosity. The typical chemical composition of oven-dried diatomaceous earth is 80% to 90% silica, with 2% to 4% alumina (attributed mostly to clay minerals) and 0.5% to 2% iron oxide.

Diatomaceous earth is currently used as a bedbug deterrent by pouring the powder around areas where the bedbugs will encounter it, such as around cracks on the floor in a bedroom, or on the floor around the headboard of a bed. However, the bedbugs can easily avoid the diatomaceous earth when it is applied is sporadic locations.

Thus, there remains a need for way to apply diatomaceous earth in a barrier that forces the bedbugs to cross the diatomaceous earth in order to reach their next meal: a sleeping human.

The present invention, as is detailed hereinbelow, seeks to fill this need by providing a double-sided tape that has a volume of diatomaceous earth continuously applied along the length of the tape.

### SUMMARY OF THE INVENTION

The present invention provides a tape for deterring and killing insects comprising: a length of double-sided tape having an adhesive on both sides of the tape; and a coating of diatomaceous earth applied in a continuous length along one of the sides of the tape and secured to the tape by the adhesive; whereby an insect is deterred from crossing the tape because the insect does not want to touch the diatomaceous earth, or an insect that has crossed the tape will die from crawling across the diatomaceous earth on the tape.

Preferably, the diatomaceous earth is non-toxic and food-grade so that it does not harm any humans or unintended animals, such as pets.

Optionally, the diatomaceous earth can include an attractant for attracting insects. The diatomaceous earth can also include a filler, a powder, or a silica.

Optionally, the invention can also include a tape dispenser that dispenses the bedbug tape and applies a coating of the diatomaceous earth to one side of the tape as the tape is dispensed therefrom.

In another embodiment hereof, there is provided a method of deterring and killing bedbugs including the steps of: providing a tape for deterring and killing insects including a length of double-sided tape having an adhesive on both sides of the tape, and a coating of diatomaceous earth applied in a continuous length along one of the sides of the tape and secured to the tape by the adhesive; and placing a length of the tape along at least one of the locations selected from the group consisting of: a bed post, a headboard on a bed, a wall, a floor, on a floor proximate a crack between the floor and a wall, an article of furniture; and a bed frame.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is an environmental view of an embodiment of the present invention showing the tape applied to the frame of a bed; and

FIG. 2 is an environmental view of the tape as applied to the walls and floor in a room.

### DETAILED DESCRIPTION OF THE PREFERRED EMBODIMENT

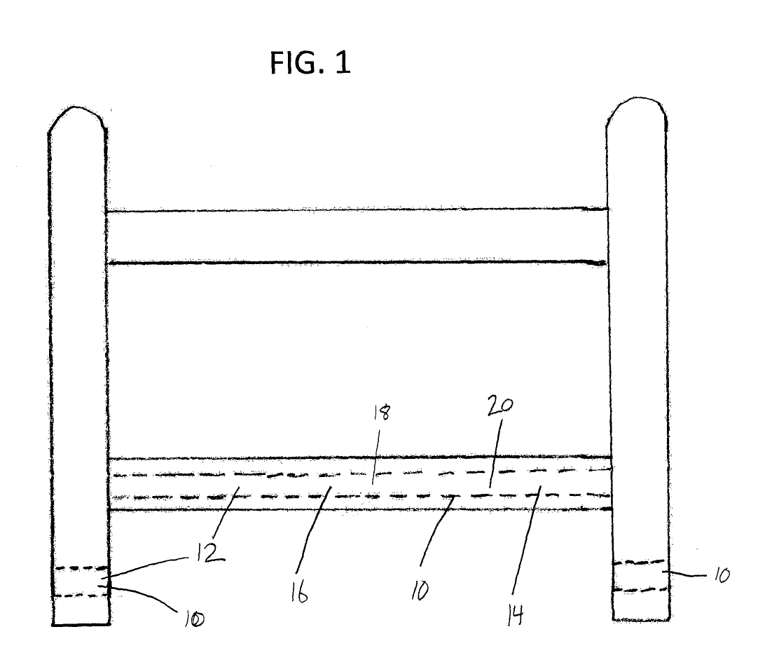

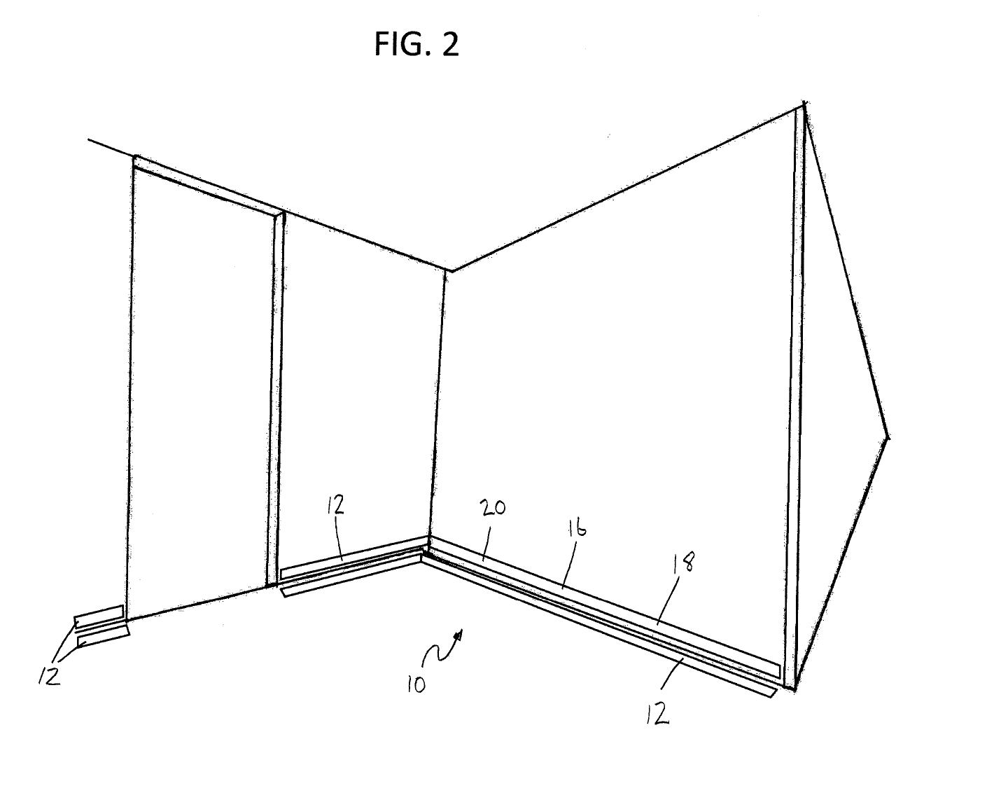

In accordance with the present invention and as shown generally in FIGS. 1 and 2, there is provided a bedbug tape 10 for deterring and killing insects comprising: a length of double-sided tape 12 having an adhesive 14 on both sides of the tape 12; and a coating of diatomaceous earth 16 applied in a continuous length along one of the sides of the tape 12 and secured to the tape 12 by the adhesive 14; whereby an insect is deterred from crossing the tape 12 because the insect does not want to touch the diatomaceous earth 16, or an insect that has crossed the tape 12 will die from crawling across the diatomaceous earth 16 on the tape 12.

The tape 12 is a double-sided tape 12 that has a layer, or coating, of food grade diatomaceous earth 16 on one side, and a peel-off backing (not shown) on the other side for installation. The tape 12 includes an adhesive 14, or glue, on both sides of the tape 12. Any suitable type of double-sided tape 12 can be used herewith, including any suitable size or color that has the adhesive 14 on both sides. The adhesive 14 is of household grade and safe for use in the home around children and pets.

As understood by those having ordinary skill in the art, diatomaceous earth is well-known as an insect deterrent and insecticide. Diatomaceous earth consists of fossilized remains of diatoms, a type of hard-shelled algae. It is used as a filtration aid, mild abrasive in products including toothpaste, and a mechanical insecticide. Insects exposed to diatomaceous earth may take several days to die. The diatomaceous earth 16 absorbs lipids from the waxy outer layer of insects' exoskeletons, causing them to dehydrate and die. The diatomaceous earth 16 is effective against bedbugs, dust mite, cockroaches, ants, and fleas.

As known by those having ordinary skill in the art, diatomaceous earth is a naturally occurring, soft, siliceous sedimentary rock that is easily crumbled into a fine white to off-white powder. It has a particle size ranging from less than 3 micrometers to more than 1 millimeter, but typically 10 to 200 micrometers. Depending on the granularity, diatomaceous earth powder can have an abrasive feel, similar to pumice powder, and it is very light as a result of its high porosity. The typical chemical composition of oven-dried diatomaceous earth 16 is 80% to 90% silica, with 2% to 4% alumina (attributed mostly to clay minerals) and 0.5% to 2% iron oxide.

Preferably, the diatomaceous earth 16 is non-toxic and food-grade so that it does not harm any humans or unintended animals, such as pets. Optionally, the diatomaceous earth 16 can include an attractant 18 for attracting insects, such as any attractants that are well-known in the art for use in insect repellants or insecticides. The diatomaceous earth 16 can also include any of the following: a filler, a powder, or a silica (collectively shown at 20). Preferably both the attractant 18 and the filler, powder, or silica are each FDA-approved.

The bedbug tape 10 can be provided to the user in one of two ways. First, the tape 12 having the adhesive 14 and peel-away liner on one side and the layer of diatomaceous earth 16 can be prepackaged into a roll, and then easily unrolled by the user and applied to the desired locations. According to this embodiment, the bedbug tape 10 would be manufactured and then packaged for sale as a single roll which is cut to length.

In another version hereof, there may be provided a tape dispenser (not shown) that dispenses the tape 12 and applies a coating of the diatomaceous earth 16 to one side of the tape 12 as the tape 12 is dispensed therefrom. As the tape 12 is pulled out of its dispenser, the tape 12 will pass through a chamber of diatomaceous earth 16, and a light coat of the diatomaceous earth 16 will be applied to the side of the tape 12 exposed to the diatomaceous earth 16. An example of this type of tape dispenser would be those sold under the trademark BANJO TAPE 12R® by Great Star Industrial USA. The tape dispensers sold by Great Star Industrial USA are specifically for use with installing drywall. These tape dispensers include a roll of tape 12 that is fed through a chamber including a volume of drywall compound. A layer of the drywall compound is coated onto the tape 12, which is then dispensed and ready for use. This type of device could be utilized for this new and non-obvious application in which a volume of diatomaceous earth 16 powder is in the tape dispenser and applied to one side of the tape 12 as the tape 12 passes through the chamber filled with the diatomaceous earth powder 16.

In another embodiment hereof, there is provided a method of deterring and killing bedbugs including the steps of: providing a tape 12 for deterring and killing insects including a length of double-sided tape 12 having an adhesive 14 on both sides of the tape 12, and a coating of diatomaceous earth 16 applied in a continuous length along one of the sides of the tape 12 and secured to the tape 12 by the adhesive 14; and placing a length of the tape 12 along at least one of the locations selected from the group consisting of: a bed post, a headboard on a bed, a wall, a floor, on a floor proximate a crack between the floor and a wall, an article of furniture; and a bed frame. It is to be understood that the tape 12 can be placed in any additional locations as determined by one having ordinary skill in the art.

It is to be appreciated that the bedbug tape 10 allows the diatomaceous earth 16 to be applied in a more controlled and consistent manner, allowing the user to put a barrier between themselves and bedbugs. Even more so, the bedbug tape 10 allows the diatomaceous earth 16 to be placed on vertical surfaces where a pile of powderized diatomaceous earth 16 cannot be placed, such as on a wall, around bedpost legs, on the back of a bed headboard, on vertical furniture surfaces, and so forth. When the bedbug tape 10 is placed around each bedpost of a bed, bedbugs must cross the barrier of diatomaceous earth 16 on the tape 12 in order to reach the human on the bed. The tape 12 can also easily create a continuous barrier around places where the bedbugs hide and travel to and from, like cracks where the floor and wall meet.

As is apparent from the preceding, the present invention provides a double-sided tape 12 that has a volume of diatomaceous earth 16 continuously applied along the length of the tape 12 which can be used to create a continuous barrier of diatomaceous earth 16 for use in deterring and killing insects such as bedbugs.

What is claimed is:

1-6. (canceled)

7. A tape for deterring and killing insects comprising:
a length of double-sided tape having an adhesive on both sides of the tape; and
a coating of diatomaceous earth applied in a continuous length along one of the sides of the tape and secured to the tape by the adhesive;
whereby an insect is deterred from crossing the tape because the insect does not want to touch the diatomaceous earth, or an insect that has crossed the tape will die from crawling across the diatomaceous earth on the tape.

8. The tape of claim 7 wherein the diatomaceous earth is non-toxic.

9. The tape of claim 8 wherein the diatomaceous earth is food-grade.

10. The tape of claim 9 wherein the diatomaceous earth includes an attractant for attracting insects.

11. The tape of claim 10 wherein the diatomaceous earth includes any of the following: a filler, a powder, or a silica.

12. The tape of claim 8 wherein the diatomaceous earth includes an attractant for attracting insects.

13. The tape of claim 12 wherein the diatomaceous earth includes any of the following: a filler, a powder, or a silica.

14. The tape of claim 8 wherein the diatomaceous earth includes any of the following: a filler, a powder, or a silica.

15. The tape of claim 9 wherein the diatomaceous earth includes any of the following: a filler, a powder, or a silica.

16. The tape of claim 7 wherein the diatomaceous earth includes an attractant for attracting insects.

17. The tape of claim 7 wherein the diatomaceous earth includes any of the following: a filler, a powder, or a silica.

18. The tape of claim 7 including a tape dispenser which applies the diatomaceous earth to the tape as the tape is dispensed from the tape dispenser.

19. The tape of claim 18 wherein the diatomaceous earth is non-toxic.

20. The tape of claim 18 wherein the diatomaceous earth includes an attractant for attracting insects.

21. The tape of claim 18 wherein the diatomaceous earth includes any of the following: a filler, a powder, or a silica.

22. A method of deterring and killing bedbugs including the steps of:
providing a tape for deterring and killing insects including a length of double-sided tape having an adhesive on both sides of the tape, and a coating of diatomaceous earth applied in a continuous length along one of the sides of the tape and secured to the tape by the adhesive; and
placing a length of the tape along at least one of the locations selected from the group consisting of: a bed post, a headboard on a bed, a wall, a floor, on a floor proximate a crack between the floor and a wall, an article of furniture; and a bed frame.
